(19) United States
(12) Patent Application Publication
(10) Pub. No.: US 2026/0104541 A1
(43) Pub. Date: Apr. 16, 2026

(54) OPTICAL ELEMENT AND MANUFACTURING METHOD

(71) Applicant: CANON KABUSHIKI KAISHA, Tokyo (JP)

(72) Inventors: KUMIKO YASHIMA, Tokyo (JP); KOUICHI YONETANI, Kanagawa (JP); KANETO TSUNEMITSU, Kanagawa (JP)

(21) Appl. No.: 19/351,542

(22) Filed: Oct. 7, 2025

(30) Foreign Application Priority Data
Oct. 15, 2024 (JP) 2024-179645

(51) Int. Cl. G02B 5/30

(52) U.S. Cl. CPC G02B 5/3025

(57) ABSTRACT

An optical element includes an optical film which is uniaxially oriented and a substrate. The optical film is bonded to a curved surface of the substrate through an adhesive layer. A second phase difference between a polarization component in a stretching direction and a polarization component in a direction orthogonal to the stretching direction in at least a partial area of an outer peripheral portion of the substrate is smaller than a first phase difference between a polarization component in the stretching direction and a polarization component in the direction orthogonal to the stretching direction in a center portion of the substrate.

### BACKGROUND

### Field of the Technology

The present disclosure relates to an optical element in which an optical film that is uniaxially oriented is bonded to a curved surface of a substrate through an adhesive layer, and a manufacturing method of the optical element.

### Description of the Related Art

In recent years, a head-mounted display (HMD) has been used in various fields such as virtual reality (VR), augmented reality (AR), and mixed reality (MR). The head-mounted display has an optical system configured to form images, displayed on displays, at positions of user's eyes. In the head-mounted display, a compact, lightweight, and high-image-quality optical system is realized by folding an optical path using circularly polarized light and a half mirror. Further, the head-mounted display is further reduced in size and weight by using an optical element in which an optical film having desired optical characteristics is bonded to a substrate having a curved surface. The optical film includes, for example, a polarizing film, a reflective polarizing film (polarizing beam splitter (PBS) film), and a phase difference film. Japanese Patent Laid-Open No. 2022-091938 discloses an optical element to which the reflective polarizing film is bonded.

However, when an optical element in which an optical film, such as a reflective polarizing film that is uniaxially oriented, is bonded to a substrate having a curved surface is exposed to a temperature change such as a high temperature or a low temperature, or when the optical element is subjected to an impact, a defective adhesion portion (rising-up) of the optical film may occur at a peripheral portion of the optical element. This is because the optical film is bonded to the curved surface of the substrate in a state in which a stress is held inside the optical film by the optical film being stretched and the internal stress of the optical film further increases due to a temperature change such as an endurance test, so that a defective adhesion such as a rising-up or peeling may occur.

### SUMMARY

The present disclosure is directed to an optical element in which an optical film that is uniaxially oriented is bonded to a curved surface of a substrate through an adhesive layer, the optical element being configured to suppress an occurrence of a defective adhesion of the optical film in an outer peripheral portion of the optical element even when the optical element is affected by an environment.

According to an embodiment of the present disclosure, an optical element comprises: an optical film which is uniaxially oriented; and a substrate, wherein the optical film is bonded to a curved surface of the substrate through an adhesive layer, and wherein a second phase difference between a polarization component in a stretching direction and a polarization component in a direction orthogonal to the stretching direction in at least a partial area of an outer peripheral portion of the substrate is smaller than a first phase difference between a polarization component in the stretching direction and a polarization component in the direction orthogonal to the stretching direction in a center portion of the substrate.

Features of the present disclosure will become apparent from the following description of embodiments with reference to the attached drawings. The following description of embodiments is described by way of example.

### BRIEF DESCRIPTION OF THE DRAWINGS

FIG. 1A is a front view of an optical element of a first embodiment.

FIG. 1B is a cross-sectional view of the optical element taken along a line IB-IB of FIG. 1A.

FIG. 2A, FIG. 2B, FIG. 2C, FIG. 2D, FIG. 2E, FIG. 2F, and FIG. 2G are views showing a manufacturing method of the optical element.

FIG. 3 is a perspective view of an optical apparatus including the optical element.

FIG. 4 is a cross-sectional view of a camera including the optical element.

FIG. 5A is a side view showing an HMD as a display apparatus.

FIG. 5B is a front view showing the HMD.

FIG. 5C is an explanatory view of a structure of a display unit of the HMD.

FIG. 6A is a front view of an optical element of a second embodiment.

FIG. 6B is a cross-sectional view of the optical element taken along a line VIB-VIB of FIG. 6A.

FIG. 7A is a front view of an optical element of a third embodiment.

FIG. 7B is a cross-sectional view of the optical element taken along a line VIIB-VIIB of FIG. 7A.

FIG. 8A is a front view of an optical element of a fourth embodiment.

FIG. 8B is a cross-sectional view of the optical element taken along a line VIIIB-VIIIB of FIG. 8A.

FIG. 9A is a front view of an optical element of a fifth embodiment.

FIG. 9B is a cross-sectional view of the optical element taken along a line IXB-IXB of FIG. 9A.

FIG. 10A is a front view of an optical element of a sixth embodiment.

FIG. 10B is a cross-sectional view of the optical element taken along a line XB-XB of FIG. 10A.

FIG. 11A is a front view of an optical element of a comparative example.

FIG. 11B is a cross-sectional view of the optical element taken along a line XIB-XIB of FIG. 11A.

### DESCRIPTION OF THE EMBODIMENTS

Hereinafter, an optical element and a manufacturing method of the optical element according to the embodiments of the present disclosure will be described with reference to the accompanying drawings.

### First Embodiment

### (Optical Element)

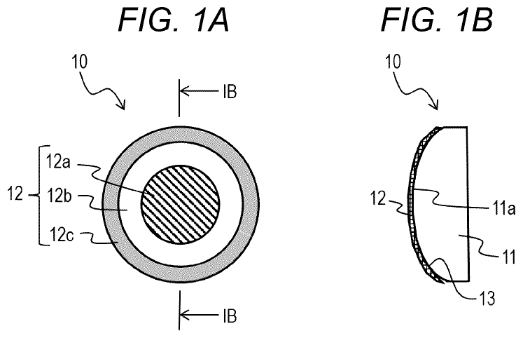

FIG. 1A and FIG. 1B are views showing an optical element 10 of a first embodiment. FIG. 1A is a front view of the optical element 10. FIG. 1B is a cross-sectional view of the optical element 10 taken along a line IB-IB of FIG. 1A. The optical element 10 includes a substrate 11, an optical film 12, and an adhesive layer 13. The substrate 11 has a convex curved surface portion 11a. The optical film 12 is bonded (attached) to the curved surface portion 11a of the substrate 11 through the adhesive layer 13.

The substrate 11 is a convex lens having a convex curved surface. However, the substrate 11 may be a concave lens having a concave curved surface. Assuming that a curvature of the curved surface portion 11a is R (for an aspherical surface, an optimum value that is obtained using the least-squares method) and a diameter of the curved surface portion 11a is L, a half open angle θ is defined by the following Equation 1.

$$sin θ = \{ ( L / 2 ) / R \} \qquad Equation 1$$

The half open angle θ may be appropriately set according to the design of the substrate 11 functioning as a lens. From the viewpoint that the substrate 11 functions as a lens, the half open angle θ is preferably 0°<θ≤30°.

### (Substrate)

The substrate 11 is molded by injection molding of a plastic mainly containing a cycloolefin copolymer (COC). However, the material of the substrate 11 is not limited to the cycloolefin copolymer, but may be a transparent plastic, glass, or the like which is transparent to light such as visible light for which the optical element 10 is intended. As the plastic material, a plastic that can be molded by injection molding and is used optically is preferable. Examples of the plastic material of the substrate 11 include polycarbonate (PC), polyester (PEs), (meth)acrylic (PMMA), and cycloolefin polymer (COP). Examples of the glass material include synthetic quartz and BK-7, which is a general glass material, although the material is not particularly limited.

### (Optical Film)

The optical film 12 is obtained by stretching (uniaxially oriented) a polymer or a multilayer polymer in one direction. The optical film 12 of the first embodiment is a reflective polarizing film. The reflective polarizing film is constituted so as to have a reflective polarizing function by alternately laminating several hundreds of layers of first sheets and second sheets having different materials and refractive indices and stretching the laminated first sheets and second sheets in one direction. Since birefringence generated in the stretched first sheet and second sheet are different, light incident on the optical film 12 in a direction (reflection axis) parallel to the stretching direction is not transmitted but reflected, and light incident on the optical film 12 in a direction (transmission axis) perpendicular to the stretching direction is transmitted. The reflection axis direction of the reflective polarizing film which is uniaxially oriented is the stretching direction, and the transmission axis direction is a direction orthogonal to the stretching direction. A component of light incident on the reflective polarizing film in the stretching direction (reflection axis) and reflected is a polarization component in the stretching direction. A component of light incident on the reflective polarizing film in the direction (transmission axis) orthogonal to the stretching direction and transmitted is a polarization component in the direction orthogonal to the stretching direction.

### (Manufacturing Method of Optical Element)

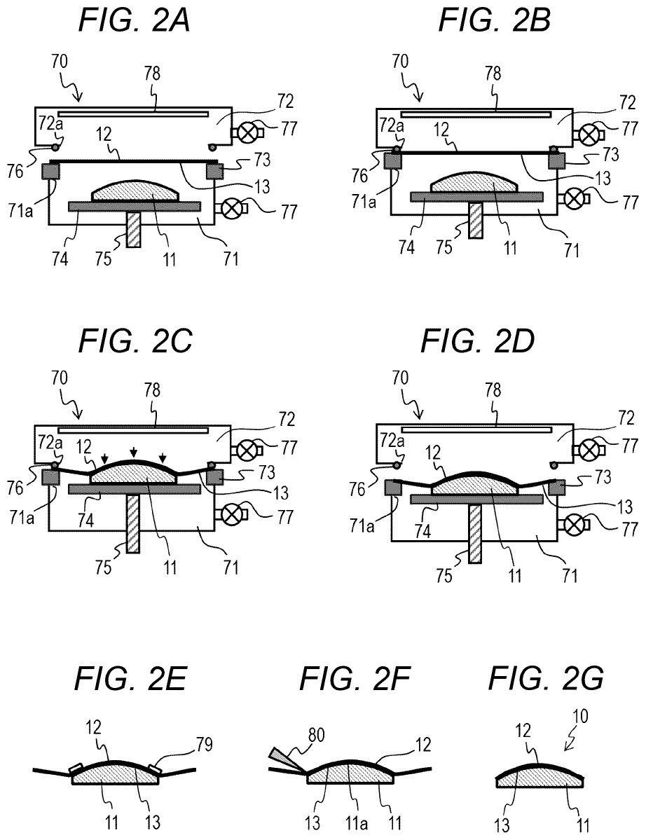

A manufacturing method of the optical element 10 will be described with reference to FIG. 2A to FIG. 2G. FIG. 2A to FIG. 2G are views showing the manufacturing method of the optical element 10. A manufacturing apparatus 70 includes a first chamber 71, a second chamber 72, a film holding portion 73, a substrate holding portion 74, a raising and lowering member 75, a sealing member 76, a vacuum device 77, and an infrared heater 78. The first chamber 71 is provided with an opening portion 71a at an upper portion of the first chamber 71. The film holding portion 73 is provided in the vicinity of the opening portion 71a of the first chamber 71. The film holding portion 73 is configured to hold the optical film 12. The second chamber 72 is provided with an opening portion 72a at a lower portion of the second chamber 72. The seal member 76 is provided in the vicinity of the opening portion 72a of the second chamber 72. The opening portion 71a of the first chamber 71 and the opening portion 72a of the second chamber 72 are arranged opposite to each other. The first chamber 71 and the second chamber 72 are configured to move toward or away from each other. The substrate holding portion 74 is configured to hold the substrate 11. The substrate holding portion 74 is configured to be raised and lowered by the raising and lowering member 75.

First, as shown in FIG. 1B, the substrate 11 made of the plastic mainly containing the cycloolefin copolymer (COC) molded by the injection molding is provided. The curved surface portion 11a of the substrate 11 has a diameter of 40 mm. The substrate 11 is a convex lens having a half open angle θ of 22°. Next, IQPE (Image Quality Polarizer Enhanced), which is the reflective polarizing film manufactured by 3M (registered trademark) Company, is provided as the optical film 12. The optical film 12 has a thickness of about 0.07 mm. The adhesive layer (glue layer) 13 is provided on one surface of the optical film 12. A size of the optical film 12 is 100 mm×100 mm.

As shown in FIG. 2A, the first chamber 71 is separated from the second chamber 72. The substrate 11 is arranged on the substrate holding portion 74 provided inside the first chamber 71. The substrate 11 is held by the substrate holding portion 74. The optical film 12 is arranged on the film holding portion 73 provided on the upper portion of the first chamber 71. The optical film 12 is held by the film holding portion 73. At this time, the optical film 12 is arranged between the first chamber 71 and the second chamber 72 so as to confront with the substrate 11 directly. The adhesive layer 13 is uniformly provided on the one surface of the optical film 12 on the side of the substrate 11. The adhesive layer 13 is formed of, for example, an optically transparent adhesive or glue. For example, the adhesive may be a transparent OCA8171 available from 3M Company located in Saint Paul, Minnesota.

A protective film (not shown) may be provided on a surface of the optical film 12 on the opposite side of the substrate 11. A glass transition temperature of the protective film is lower than a glass transition temperature of the optical film 12. By providing the protective film, the optical film 12 is less likely to be torn when the optical film 12 is bonded to the substrate 11. Since the optical film 12 is more expensive than a general film, a size slightly larger than an area of the curved surface portion 11a of the substrate 11 (an area that is 1.5 to 2.5 times the area of the curved surface portion 11a when viewed in plan) is sufficient. A support film composed of a separate member may be bonded on the optical film 12. In this case, in order to make the deflection of the optical film 12 uniform when the optical film 12 is heated, it is preferable that the support film has a glass transition temperature equal to or about 20° C. lower than the glass transition temperature of the optical film 12.

Next, as shown in FIG. 2B, the first chamber 71 and the second chamber 72 are brought close to each other and brought into contact with each other through the seal member 76, and the first chamber 71 is closed by the second chamber 72. The first chamber 71 and the second chamber 72 are connected to the vacuum devices 77, respectively. The inside of the first chamber 71 and the inside of the second chamber 72 are evacuated by the vacuum devices 77. The optical film 12 arranged between the first chamber 71 and the second chamber 72 is heated. The optical film 12 is directly heated by the infrared heater 78. However, heating means for heating the optical film 12 is not limited to the infrared heater 78, and the whole of the first chamber 71 and the second chamber 72 may be heated by a heater or the like. In a case where the whole of the first chamber 71 and the second chamber 72 is heated, it is preferable that the substrate holding portion (pedestal) 74 has a heat insulating structure so that the substrate 11 made of the plastic material is not deformed by heat. It is preferable that the temperature of the substrate 11 is maintained at 120° C. or lower regardless of the temperature of the optical film 12.

After heating the optical film 12 to a predetermined bonding temperature (for example, 150° C.), as shown in FIG. 2C, the raising and lowering member 75 is raised to bring the substrate 11 into contact with the optical film 12, and the inside of the second chamber 72 is opened to the atmosphere to increase the pressure in the second chamber 72. Thus, the optical film 12 is bonded to the curved surface of the substrate 11 through the adhesive layer 13 (bonding step). The bonding step is performed in the heated state. Further, if necessary, a high-pressure gas (for example, compressed air) is introduced into the second chamber 72 to increase the pressure in the second chamber 72 to a desired pressure (for example, 0.2 MPa), and the optical film 12 is pressurized and pressed against the substrate 11. Further, if necessary, the heating and pressurization of the optical film 12 may be continued for a predetermined period of time (for example, 30 seconds).

Next, the heating and pressurization of the optical film 12 are stopped, the pressure in the second chamber 72 is returned to the atmospheric pressure, and the inside of the first chamber 71 is also opened to the atmosphere. Then, as shown in FIG. 2D, the second chamber 72 is separated from the first chamber 71.

Next, the substrate 11 to which the optical film 12 is bonded is taken out of the manufacturing apparatus 70. As shown in FIG. 2E, a heating member 79 such as a heater is used to heat the optical film 12 on the outer peripheral portion of the substrate 11 to a predetermined heating temperature (hereinafter referred to as a post-heating temperature) as a heating step after bonding. For example, the post-heating temperature is set to 180° C. The heating member 79 is pressed against the optical film 12 on the outer peripheral portion of the substrate 11 to heat an outer peripheral portion 12c (FIG. 1A) of the optical film 12 (heating step). The post-heating temperature in the heating step is higher than the heating temperature in the bonding step. At this time, the outer peripheral portion to be heated is an area having a width of 4 mm from an end portion of the substrate 11, which is 10% of 40 mm on a diameter (lens diameter) of the curved surface portion 11a of the substrate 11. At least one portion of the outer peripheral portion of the substrate 11 bonded to the optical film 12 may be heated by the heating member 79.

When the optical film 12 is bonded to the curved surface portion 11a of the substrate 11, the optical film 12 is stretched and stress is generated inside the optical film 12. The internal stress of the optical film 12 is further increased by a temperature change such as an endurance test. For this reason, in particular, the defective adhesion such as the rising-up or peeling of the optical film 12 may occur on the outer peripheral portion of the substrate 11. Therefore, as described above, the optical film 12 on the outer peripheral portion of the substrate 11 is heated to the desired temperature by the heating member 79 to reduce the internal stress of the optical film 12. Thus, the occurrence of the defective adhesion such as the rising-up or peeling of the optical film 12 can be suppressed.

After heating the optical film 12 on the outer peripheral portion of the substrate 11, as shown in FIG. 2F, an unnecessary portion of the optical film 12 is cut out by applying a blade 80 along an outer edge of the curved surface portion 11a to leave the optical film 12 on the curved surface portion 11a of the substrate 11. Cutting means is not limited to the blade 80 but may be configured to cut out the unnecessary portion of the optical film 12 by applying a laser beam along the outer edge of the curved surface portion 11a. In this manner, as shown in FIG. 2G, the optical element 10 in which the optical film 12 is bonded to the curved surface portion 11a of the substrate 11 is manufactured. The optical element 10 of the first embodiment is a reflective polarizing optical element in which a reflective polarizing film as the optical film 12 is bonded to the substrate 11 through the adhesive layer 13.

### (Phase Difference Measurement)

In order to evaluate the stress inside the optical film 12, a phase difference σ (nm) is measured. As can be understood from Equation 2 below, it is known that the stress F accumulated in the optical film 12 has a correlation with the phase difference σ, where d (cm) is the thickness of the optical film 12 and β (/10⁵ Pa) is a photo-elastic coefficient of the optical film 12.

$$F = σ ( β \times d ) \qquad Equation 2$$

That is, it is effective to measure the phase difference σ in order to evaluate that the stress at the outer peripheral portion 12c (FIG. 1A) of the optical film 12 is reduced by the manufacturing method of the optical element 10 of the first embodiment. In the first embodiment, as shown in FIG. 1A, the optical film 12 is divided into a center portion 12a, a middle band portion 12b, and the outer peripheral portion 12c. A phase difference (first phase difference) at the center portion 12a of the optical film 12 and a phase difference (second phase difference) at the outer peripheral portion 12c are measured, and the stress inside the optical film 12 is evaluated based on the measurement results of the phase differences.

In the optical element 10, the center portion 12a of the optical film 12 is located at a position corresponding to the center portion of the optical element 10 and the center portion of the substrate 11. In the optical element 10, the outer peripheral portion 12c of the optical film 12 is located at a position corresponding to the outer peripheral portion of the optical element 10 and the outer peripheral portion of the substrate 11. Therefore, for convenience of explanation, the center portion 12a of the optical film 12 is referred to as the center portion 12a of the optical element 10 or the substrate 11, and the outer peripheral portion 12c of the optical film 12 is referred to as the outer peripheral portion 12c of the optical element 10 or the substrate 11. The phase difference of the optical element 10 is measured using a phase difference measuring apparatus KOBRA (manufactured by Oji Scientific Instruments Co., Ltd.), but may be measured using another apparatus. An average value RET1 (nm) of the phase difference of the center portion 12a of the optical element 10 and an average value RET2 (nm) of the phase difference of the outer peripheral portion 12c of the optical element 10 are measured. Since the phase difference and the stress held in the optical film 12 are proportional to each other, the average value RET2 of the phase difference of the outer peripheral portion 12c must be smaller than the average value RET1 of the phase difference of the center portion 12a. According to the study by the inventors, when a ratio (RET2/RET1) of the average value RET2 of the phase difference of the outer peripheral portion 12c to the average value RET1 of the phase difference of the center portion 12a is 97% or less, the durability of the optical element 10 in the high-temperature and low-temperature tests is good. Therefore, when RET2/RET1 is 97% or less, it is determined that the stress inside the optical film 12 is sufficiently reduced.

The optical element 10 of the first embodiment is evaluated using the phase difference measuring apparatus KOBRA. An area within a diameter of 20 mm corresponding to a diameter of 50% from a center of the optical element 10 is defined as the center portion 12a. The average value RET1 of the phase difference (first phase difference) between the polarization component in the stretching direction and the polarization component in the direction orthogonal to the stretching direction in the center portion 12a of the substrate 11 is calculated. The area of the optical element 10 heated by the heating member 79 and having a width of 4 mm from the end portion of the substrate 11 is defined as the outer peripheral portion 12c. The average value RET2 of the phase difference (second phase difference) between the polarization component in the stretching direction and the polarization component in the direction orthogonal to the stretching direction in the outer peripheral portion 12c of the substrate 11 is calculated. RET2/RET1, which is the ratio of the phase difference (second phase difference) in the outer peripheral portion 12c to the phase difference (first phase difference) in the center portion 12a calculated from the average values RET1 and RET2, is 97%. Therefore, RET2/RET1 of the optical element 10 of the first embodiment is 97% or less.

(Appearance Evaluation after Endurance Test)

The appearance of the optical element 10 of the first embodiment is evaluated. The appearance of the optical element 10 can be evaluated, for example, by observing a state of the end portion with a microscope. In the first embodiment, a digital microscope VHX (manufactured by Keyence Corporation) is used as the microscope. Specifically, an area of 2 mm inside from the end portion of the substrate 11 is observed with the microscope. In a case where a rising-up having a width of 200 μm or more is not confirmed, since peeling is not affected in the endurance test under a high temperature environment, the optical element 10 is evaluated to be excellent. Further, as a temperature cycle test, a temperature cycle test of 30 minutes at 70° C. and 30 minutes at −30° C. is repeated for 30 cycles, and a state of the end portion of the optical element 10 after the temperature cycle test is observed with the microscope, and it is confirmed whether peeling has developed to an area of 2 mm or more from the end portion of the substrate 11.

Table 1 below is a table showing the specifications and evaluation results of the optical elements of the first embodiment, and a second embodiment to a sixth embodiment and a comparative example described later. Since rising-up and peeling are not confirmed in the appearance evaluation after the temperature cycle test of the optical element 10 of the first embodiment, the appearance of the optical element 10 of the first embodiment is judged to be good (o) as shown in Table 1. According to the first embodiment, even when the optical element 10 is affected by the environment, the occurrence of defective adhesion of the optical film 12 in the outer peripheral portion 12c of the optical element 10 can be suppressed.

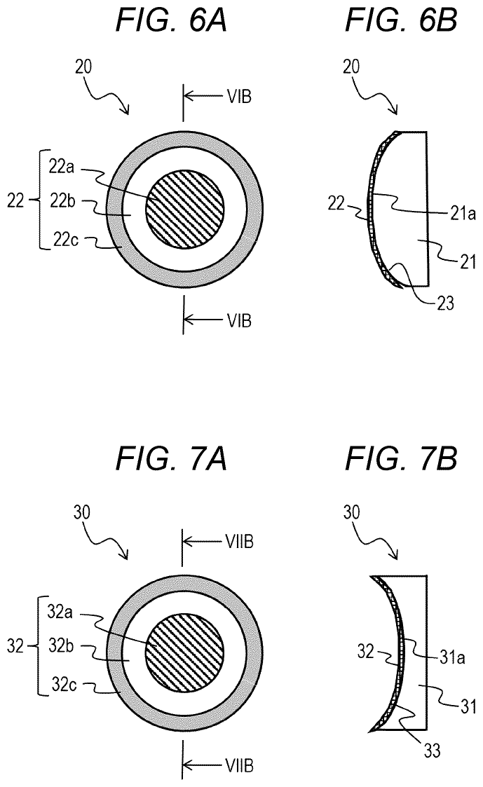

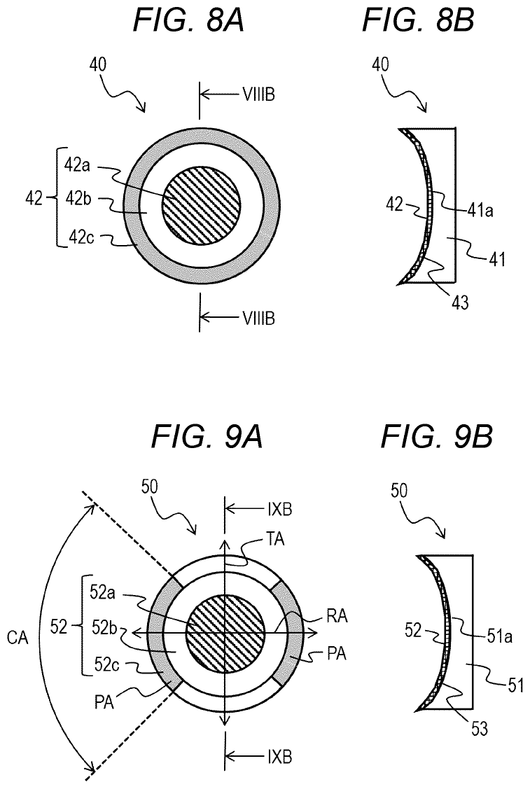

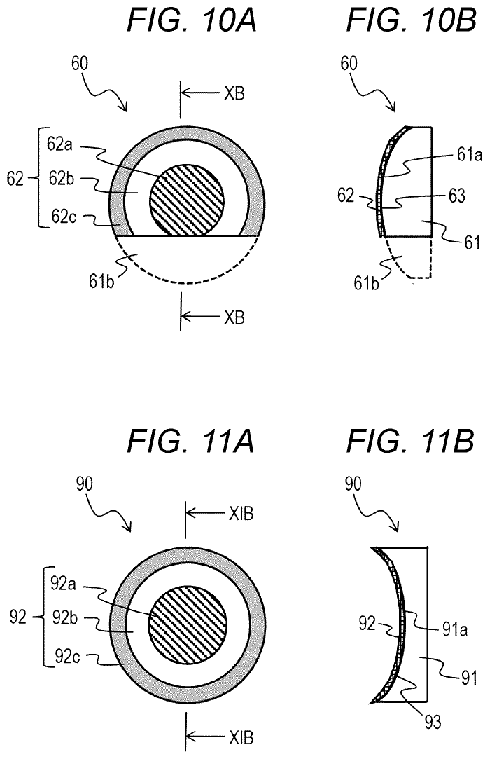

TABLE 1

| | | | | | | OUTER | | |
|---|---|---|---|---|---|---|---|---|
| | | HALF | | POST- | CENTER | PERIPHERAL | | APPEARANCE |
| | LENS | OPEN | BONDING | HEATING | PORTION | PORTION | | AFTER |
| | SHAPE | ANGLE/° | TEMP/° C. | TEMP/° C. | RET1/nm | RET2/nm | RET1/RET2 | ENDURANCE |
| FIRST | FIG. 1A | 22 | 150 | 180 | 160 | 155 | 97% | ∘ |
| EMBODIMENT | FIG. 1B | | | | | | | |
| COMPARATIVE | FIG. 11A | 22 | 150 | — | 160 | 162 | 101% | x |
| EXAMPLE | FIG. 11B | | | | | | | |
| SECOND | FIG. 6A | 12 | 120 | 140 | 150 | 130 | 87% | ∘ |
| EMBODIMENT | FIG. 6B | | | | | | | |
| THIRD | FIG. 7A | 22 | 150 | 190 | 160 | 152 | 95% | ∘ |
| EMBODIMENT | FIG. 7B | | | | | | | |
| FOURTH | FIG. 8A | 12 | 130 | 190 | 155 | 150 | 97% | ∘ |
| EMBODIMENT | FIG. 8B | | | | | | | |
| FIFTH | FIG. 9A | 22 | 150 | 200 | 160 | 130 | 81% | ∘ |
| EMBODIMENT | FIG. 9A | | | | | | | |
| SIXTH | FIG. 10A | 22 | 150 | 200 | 160 | 145 | 91% | ∘ |
| EMBODIMENT | FIG. 10B | | | | | | | |

The optical element 10 can be applied to various devices and apparatuses such as optical apparatuses, image pickup apparatuses, and display apparatuses. Hereinafter, as specific application examples of the optical element 10, an optical apparatus, an image pickup apparatus, and a display apparatus will be described.

### (Optical Apparatus)

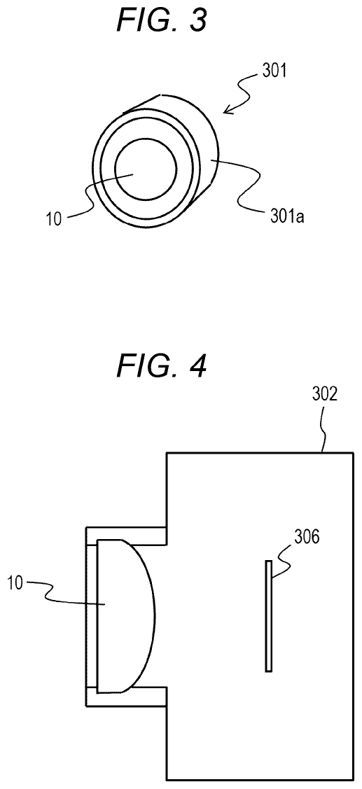

Specific application examples of the optical element 10 include lenses constituting optical apparatuses (photographing optical systems) for cameras and video cameras, and lenses constituting optical apparatuses (projection optical systems) for liquid crystal projectors. The optical element 10 can also be used as a pickup lens of an optical apparatus such as a DVD recorder. FIG. 3 is a perspective view of an optical apparatus 301 including the optical element 10. The optical apparatus 301 is a lens barrel in which the optical element 10 is used as at least one lens arranged in a housing (barrel) 301a.

### (Image Pickup Apparatus)

FIG. 4 is a cross-sectional view of a camera 302 including the optical element 10. The camera (body) 302 as an image pickup apparatus includes the optical element 10 and an image pickup element 306 for receiving an image formed by the optical element 10. The image pickup element 306 is a solid-state image pickup element (photoelectric conversion element) such as a CCD (Charge Coupled Device) sensor or a CMOS (Complementary Metal Oxide Semiconductor) sensor for converting the received light into an electric signal.

### (Display Apparatus)

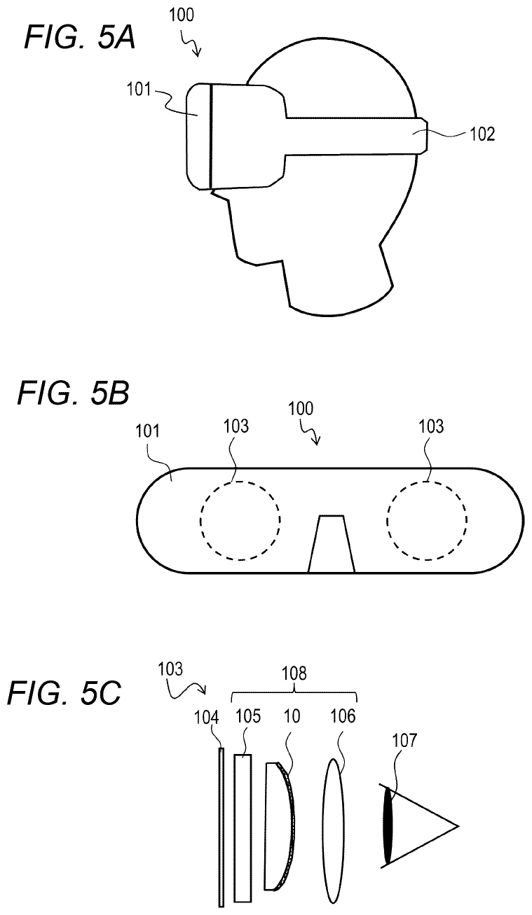

FIG. 5A, FIG. 5B, and FIG. 5C are schematic views showing a configuration of a head-mounted display (hereinafter referred to as HMD) 100 including the optical element 10. FIG. 5A is a side view showing the HMD100 as a display apparatus. FIG. 5B is a front view showing the HMD100. FIG. 5C is an explanatory view of a structure of a display unit 103 of the HMD100. As shown in FIG. 5A and FIG. 5B, the HMD100 has a housing 101, a mounting equipment 102, and display units 103 for the left eye and the right eye. The display units 103 for the left eye and the right eye are respectively provided in the housing 101. The HMD100 is mounted on the head of a user by the mounting equipment 102 so that the display units 103 for the left eye and the right eye are respectively positioned corresponding to the left eye and the right eye of the user.

As shown in FIG. 5C, each display unit 103 has a display panel (display portion) 104 and an optical system 108 configured to guide light emitted from the display panel. The optical system 108 includes an optical member 105, the optical element 10, and an optical member 106. The optical system 108 includes one optical element 10 but may include two or more optical elements 10. The optical system 108 may include at least one optical element 10. The display panel 104 and the optical system 108 are arranged in the housing 101. The display panel 104 is a display portion of an organic electroluminescence (EL) panel, a liquid crystal panel, or the like, and displays a corresponding image for the left eye or the right eye. The optical system 108 forms an image of the image light emitted from the display panel 104 at the position of the user's eye 107. The optical members 105 and 106 included in the optical system 108 may include a transmission optical element such as a convex lens or a concave lens, a reflection optical element such as a concave mirror, a mirror, a half mirror, an optical path changing element such as a polarizing beam splitter (PBS), and the like, depending on the design of the HMD100. The optical element 10 is arranged between the optical member 105 and the eye 107. The optical element 10, together with the optical members 105 and 106, constitutes the optical system 108 configured to guide the image light, which is the light emitted from the display panel 104, to the user's eye 107. The optical element 10 functions as at least one lens in the optical system 108.

Although the HMD100 has been described as a display apparatus including the optical element 10, the display apparatus is not limited to this. For example, the optical element 10 may be used in a display apparatus such as a projector.

### Second Embodiment

### (Optical Element)

An optical element 20 of a second embodiment will now be described with reference to FIG. 6A and FIG. 6B. FIG. 6A and FIG. 6B are views showing the optical element 20 of the second embodiment. FIG. 6A is a front view of the optical element 20. FIG. 6B is a cross-sectional view of the optical element 20 taken along a line VIB-VIB of FIG. 6A. The optical element 20 includes a substrate 21, an optical film 22, and an adhesive layer 23. The substrate 21 has a convex curved surface portion 21a. The optical film 22 is bonded to the curved surface portion 21a of the substrate 21 through the adhesive layer 23. The adhesive layer 23 is formed of, for example, an optically transparent adhesive or glue.

### (Optical Film)

While the optical film 12 of the optical element 10 of the first embodiment is the reflective polarizing film, the optical film 22 of the optical element 20 of the second embodiment is a phase difference film in which the COP, COC or PC is stretched in one direction (uniaxially oriented). The phase difference film has a fast axis and a slow axis orthogonal to the fast axis. A slow axis orientation of the phase difference film which is uniaxially oriented is a stretching direction, and a fast axis orientation is a direction orthogonal to the stretching direction. The phase difference film can delay a phase of light incident parallel to the slow axis by a predetermined wavelength and emit the delayed light. Examples of the phase difference film include a ½ wavelength film in which the phase of light incident parallel to the slow axis is delayed by half a wavelength, a ¼ wavelength film in which the phase of light incident parallel to the slow axis is delayed by ¼ wavelength, and the like. A component of light incident on the phase difference film in the stretching direction (slow axis) and emitted with a predetermined wavelength delay is a polarization component in the stretching direction. A component of light incident on the phase difference film in the direction (fast axis) orthogonal to the stretching direction and transmitting through the phase difference film is a polarization component in the direction orthogonal to the stretching direction.

### (Manufacturing Method of Optical Element)

The manufacturing apparatus 70 configured to manufacture the optical element 20 of the second embodiment is the same as that of the first embodiment, and therefore a description thereof is omitted. First, the substrate 21 made of plastic mainly composed of COC molded by injection molding is provided. The curved surface portion 21a of the substrate 21 has a diameter of 50 mm. The substrate 21 is a convex lens made of plastic and having a half open angle θ of 12°. Next, a ¼ wavelength film manufactured by NIPPON KAYAKU CO., LTD is provided as the optical film 22. The optical film 22 has a thickness of 0.1 mm. An adhesive layer 23 is provided on one surface of the optical film 22.

As in the first embodiment described with reference to FIG. 2A to FIG. 2G, the substrate 21 is arranged on the substrate holding portion 74 of the manufacturing apparatus 70, and the optical film 22 is arranged on the film holding portion 73. The bonding temperature of the optical film 22 is set to 120° C., and the optical film 22 is bonded to the substrate 21 through the adhesive layer 23 (bonding step). The substrate 21 to which the optical film 22 is bonded is taken out of the manufacturing apparatus 70, and an outer peripheral portion (an area having a width of 5 mm from the end portion) of the substrate 21 is heated by the heating member 79 at a post-heating temperature of 140° C. (heating step). The post-heating temperature in the heating step is higher than the heating temperature in the bonding step. At least one portion of the outer peripheral portion of the substrate 21 to which the optical film 22 is bonded may be heated by the heating member 79. An unnecessary portion of the optical film 22 is cut out by applying the blade 80 along the outer edge of the substrate 21 to manufacture the optical element 20. The optical element 20 of the second embodiment is a phase difference optical element in which the phase difference film as the optical film 22 is bonded to the substrate 21 through the adhesive layer 23.

### (Phase Difference Measurement)

The optical element 20 of the second embodiment is evaluated using the phase difference measuring apparatus KOBRA. In the second embodiment, as shown in FIG. 6A, the optical film 22 is divided into a center portion 22a, a middle band portion 22b, and an outer peripheral portion 22c. An area within a diameter of 25 mm corresponding to a diameter of 50% from a center of the optical element 20 is defined as the center portion 22a. The average value RET1 of the phase difference (first phase difference) between the polarization component in the stretching direction and the polarization component in the direction orthogonal to the stretching direction in the center portion 22a of the substrate 21 is calculated. The area of the optical element 20 heated by the heating member 79 and having a width of 5 mm from the end portion of the substrate 21 is defined as the outer peripheral portion 22c. The average value RET2 of the phase difference (second phase difference) between the polarization component in the stretching direction and the polarization component in the direction orthogonal to the stretching direction in the outer peripheral portion 22c of the substrate 21 is calculated. RET2/RET1, which is the ratio of the phase difference (second phase difference) in the outer peripheral portion 22c to the phase difference (first phase difference) in the center portion 22a calculated from the average values RET1 and RET2, is 87%. Therefore, RET2/RET1 of the optical element 20 of the second embodiment is 97% or less.

(Appearance Evaluation after Endurance Test)

Since rising-up and peeling are not confirmed in the appearance evaluation after the temperature cycle test of the optical element 20 of the second embodiment, the appearance of the optical element 20 of the second embodiment is judged to be good (o) as shown in Table 1. According to the second embodiment, even when the optical element 20 is affected by the environment, the occurrence of defective adhesion of the optical film 22 in the outer peripheral portion 22c of the optical element 20 can be suppressed. Similarly to the first embodiment, the optical element 20 of the second embodiment can be applied to various devices and apparatuses such as optical apparatuses, image pickup apparatuses, and display apparatuses.

### Third Embodiment

### (Optical Element)

An optical element 30 of a third embodiment will now be described with reference to FIG. 7A and FIG. 7B. FIG. 7A and FIG. 7B are views showing the optical element 30 of the third embodiment. FIG. 7A is a front view of the optical element 30. FIG. 7B is a cross-sectional view of the optical element 30 taken along a line VIIB-VIIB of FIG. 7A. The optical element 30 includes a substrate 31, an optical film 32, and an adhesive layer 33. The substrate 31 has a concave curved surface portion 31a. The optical film 32 is bonded to the curved surface portion 31a of the substrate 31 through the adhesive layer 33. The adhesive layer 33 is formed of, for example, an optically transparent adhesive or glue.

### (Manufacturing Method of Optical Element)

The manufacturing apparatus 70 configured to manufacture the optical element 30 of the third embodiment is the same as that of the first embodiment, and therefore a description thereof is omitted. First, the substrate 31 made of glass is provided. The curved surface portion 31a of the substrate 31 has a diameter of 40 mm. The substrate 31 is a concave lens made of glass having a half open angle θ of 22°. Next, as the optical film 32, IQPE, which is the reflective polarizing film manufactured by 3M Company, is provided as in the first embodiment.

As in the first embodiment described with reference to FIG. 2A to FIG. 2G, the substrate 31 is arranged on the substrate holding portion 74 of the manufacturing apparatus 70, and the optical film 32 is arranged on the film holding portion 73. The bonding temperature of the optical film 32 is set to 150° C., and the optical film 32 is bonded to the substrate 31 through the adhesive layer 33 (bonding step). The substrate 31 to which the optical film 32 is bonded is taken out of the manufacturing apparatus 70, and an outer peripheral portion (an area having a width of 4 mm from the end portion) of the substrate 31 is heated by the heating member 79 at a post-heating temperature of 190° C. (heating step). The post-heating temperature in the heating step is higher than the heating temperature in the bonding step. At least one portion of the outer peripheral portion of the substrate 31 to which the optical film 32 is bonded may be heated by the heating member 79. An unnecessary portion of the optical film 32 is cut out by applying the blade 80 along the outer edge of the substrate 31 to manufacture the optical element 30. The optical element 30 of the third embodiment is a reflective polarizing optical element in which the reflective polarizing film as the optical film 32 is bonded to the substrate 31 through the adhesive layer 33.

### (Phase Difference Measurement)

The optical element 30 of the third embodiment is evaluated using the phase difference measuring apparatus KOBRA. In the third embodiment, as shown in FIG. 7A, the optical film 32 is divided into a center portion 32a, a middle band portion 32b, and an outer peripheral portion 32c. An area within a diameter of 20 mm corresponding to a diameter of 50% from a center of the optical element 30 is defined as the center portion 32a. The average value RET1 of the phase difference (first phase difference) between the polarization component in the stretching direction and the polarization component in the direction orthogonal to the stretching direction in the center portion 32a of the substrate 31 is calculated. The area of the optical element 30 heated by the heating member 79 and having a width of 4 mm from the end portion of the substrate 31 is defined as the outer peripheral portion 32c. The average value RET2 of the phase difference (second phase difference) between the polarization component in the stretching direction and the polarization component in the direction orthogonal to the stretching direction in the outer peripheral portion 32c of the substrate 31 is calculated. RET2/RET1, which is the ratio of the phase difference (second phase difference) in the outer peripheral portion 32c to the phase difference (first phase difference) in the center portion 32a calculated from the average values RET1 and RET2, is 95%. Therefore, RET2/RET1 of the optical element 30 of the third embodiment is 97% or less.

### (Appearance Evaluation After Endurance Test)

Since rising-up and peeling are not confirmed in the appearance observation after the completion of the temperature cycle test of the optical element 30 of the third embodiment, the appearance of the optical element 30 of the third embodiment is judged to be good (o) as shown in Table 1. According to the third embodiment, even when the optical element 30 is affected by the environment, the occurrence of defective adhesion of the optical film 32 in the outer peripheral portion 32c of the optical element 30 can be suppressed. Similarly to the first embodiment, the optical element 30 of the third embodiment can be applied to various devices and apparatuses such as optical apparatuses, image pickup apparatuses, and display apparatuses.

### Fourth Embodiment

### (Optical Element)

An optical element 40 of a fourth embodiment will now be described with reference to FIG. 8A and FIG. 8B. FIG. 8A and FIG. 8B are views showing the optical element 40 of the fourth embodiment. FIG. 8A is a front view of the optical element 40. FIG. 8B is a cross-sectional view of the optical element 40 taken along a line VIIIB-VIIIB of FIG. 8A. The optical element 40 includes a substrate 41, an optical film 42, and an adhesive layer 43. The substrate 41 has a concave curved surface portion 41a. The optical film 42 is bonded to the curved surface portion 41a of the substrate 41 through the adhesive layer 43. The adhesive layer 43 is formed of, for example, an optically transparent adhesive or glue.

### (Manufacturing Method of Optical Element)

The manufacturing apparatus 70 configured to manufacture the optical element 40 of the fourth embodiment is the same as that of the first embodiment, and therefore a description thereof is omitted. First, the substrate 41 made of plastic is provided. The curved surface portion 41a of the substrate 41 has a diameter of 50 mm. The substrate 41 is a concave lens made of plastic having a half open angle θ of 12°. Next, as the optical film 42, IQPE, which is the reflective polarizing film manufactured by 3M Company, is provided as in the first embodiment.

As in the first embodiment described with reference to FIG. 2A to FIG. 2G, the substrate 41 is arranged on the substrate holding portion 74 of the manufacturing apparatus 70, and the optical film 42 is arranged on the film holding portion 73. The bonding temperature of the optical film 42 is set to 130° C., and the optical film 42 is bonded to the substrate 41 through the adhesive layer 43 (bonding step). The substrate 41 to which the optical film 42 is bonded is taken out of the manufacturing apparatus 70, and an outer peripheral portion (an area having a width of 5 mm from the end portion) of the substrate 41 is heated by the heating member 79 at a post-heating temperature of 190° C. (heating step). The post-heating temperature in the heating step is higher than the heating temperature in the bonding step. At least one portion of the outer peripheral portion of the substrate 41 to which the optical film 42 is bonded may be heated by the heating member 79. An unnecessary portion of the optical film 42 is cut out by applying the blade 80 along the outer edge of the substrate 41 to manufacture the optical element 40. The optical element 40 of the fourth embodiment is a reflective polarizing optical element in which the reflective polarizing film as the optical film 42 is bonded to the substrate 41 through the adhesive layer 43.

### (Phase Difference Measurement)

The optical element 40 of the fourth embodiment is evaluated using the phase difference measuring apparatus KOBRA. In the fourth embodiment, as shown in FIG. 8A, the optical film 42 is divided into a center portion 42a, a middle band portion 42b, and an outer peripheral portion 42c. An area within a diameter of 25 mm corresponding to a diameter of 50% from a center of the optical element 40 is defined as the center portion 42a. The average value RET1 of the phase difference (first phase difference) between the polarization component in the stretching direction and the polarization component in the direction orthogonal to the stretching direction in the center portion 42a of the substrate 41 is calculated. The area of the optical element 40 heated by the heating member 79 and having a width of 5 mm from the end portion of the substrate 41 is defined as the outer peripheral portion 42c. The average value RET2 of the phase difference (second phase difference) between the polarization component in the stretching direction and the polarization component in the direction orthogonal to the stretching direction in the outer peripheral portion 42c of the substrate 41 is calculated. RET2/RET1, which is the ratio of the phase difference (second phase difference) in the outer peripheral portion 42c to the phase difference (first phase difference) in the center portion 42a calculated from the average values RET1 and RET2, is 97%. Therefore, RET2/RET1 of the optical element 40 of the fourth embodiment is 97% or less.

### (Appearance Evaluation After Endurance Test)

Since rising-up and peeling are not confirmed in the appearance observation after the completion of the temperature cycle test of the optical element 40 of the fourth embodiment, the appearance of the optical element 40 of the fourth embodiment is judged to be good (o) as shown in Table 1. According to the fourth embodiment, even when the optical element 40 is affected by the environment, the occurrence of defective adhesion of the optical film 42 in the outer peripheral portion 42c of the optical element 40 can be suppressed. Similarly to the first embodiment, the optical element 40 of the fourth embodiment can be applied to various devices and apparatuses such as optical apparatuses, image pickup apparatuses, and display apparatuses.

### Fifth Embodiment

### (Optical Element)

An optical element 50 of a fifth embodiment will now be described with reference to FIG. 9A and FIG. 9B. FIG. 9A and FIG. 9B are views showing the optical element 50 of the fifth embodiment. FIG. 9A is a front view of the optical element 50. FIG. 9B is a cross-sectional view of the optical element 50 taken along a line IXB-IXB of FIG. 9A. The optical element 50 includes a substrate 51, an optical film 52, and an adhesive layer 53. The substrate 51 has a concave curved surface portion 51a. The optical film 52 is bonded to the curved surface portion 51a of the substrate 51 through the adhesive layer 53. The adhesive layer 53 is formed of, for example, an optically transparent adhesive or glue.

### (Manufacturing Method of Optical Element)

The manufacturing apparatus 70 configured to manufacture the optical element 50 of the fifth embodiment is the same as that of the first embodiment, and therefore a description thereof is omitted. First, the substrate 51 made of plastic is provided. The curved surface portion 51a of the substrate 51 has a diameter of 45 mm. The substrate 51 is a concave lens made of plastic having a half open angle θ of 22°. Next, as the optical film 52, IQPE, which is the reflective polarizing film manufactured by 3M Company, is provided as in the first embodiment.

As in the first embodiment described with reference to FIG. 2A to FIG. 2G, the substrate 51 is arranged on the substrate holding portion 74 of the manufacturing apparatus 70, and the optical film 52 is arranged on the film holding portion 73. The bonding temperature of the optical film 52 is set to 150° C., and the optical film 52 is bonded to the substrate 51 through the adhesive layer 53 (bonding step). The substrate 51 to which the optical film 52 is bonded is taken out of the manufacturing apparatus 70, and predetermined areas PA (at least one portion of the outer peripheral portion) of an area having a width of 4.5 mm from the end portion of the substrate 51 are heated by the heating member 79 at a post-heating temperature of 200° C. (heating step). The post-heating temperature in the heating step is higher than the heating temperature in the bonding step.

The predetermined areas PA are areas on opposite sides about a transmission axis TA passing through the center of the optical film 52, that is, the areas on both ends in the direction of a reflection axis RA passing through the center of the optical film 52. Each of the predetermined areas PA has an arc shape with the center of the substrate 51 as the center and extends to both sides about the reflection axis RA passing through the center of the optical film 52. A center angle CA of each of the predetermined areas PA is about 90°. The direction of the reflection axis RA is the stretching direction of the optical film 52. The optical film 52 obtained by being stretched in one direction tends to have internal stress in the stretching direction. Therefore, it is effective to reduce the internal stress by heating the predetermined areas PA at both ends in the direction of the reflection axis RA parallel to the stretching direction.

An unnecessary portion of the optical film 52 is cut out by applying the blade 80 along the outer edge of the substrate 51 to manufacture the optical element 50. The optical element 50 of the fifth embodiment is a reflective polarizing optical element in which the reflective polarizing film as the optical film 52 is bonded to the substrate 51 through the adhesive layer 53.

### (Phase Difference Measurement)

The optical element 50 of the fifth embodiment is evaluated using the phase difference measuring apparatus KOBRA. In the fifth embodiment, as shown in FIG. 9A, the optical film 52 is divided into a center portion 52a, a middle band portion 52b, and an outer peripheral portion 52c. An area within a diameter of 22.5 mm corresponding to a diameter of 50% from the center of the optical element 50 is defined as the center portion 52a. The average value RET1 of the phase difference (first phase difference) between the polarization component in the stretching direction and the polarization component in the direction orthogonal to the stretching direction in the center portion 52a of the substrate 51 is calculated. The area having the width of 4.5 mm from the end portion of the substrate 51 is defined as the outer peripheral portion 52c. The arc-shaped area heated by the heating member 79 and having the center angle CA of 90°, which is at least one portion of the outer peripheral portion 52c, is defined as the predetermined area PA. The average value RET2 of the phase difference (second phase difference) between the polarization component in the stretching direction and the polarization component in the direction orthogonal to the stretching direction in the at least one portion (predetermined area PA) of the outer peripheral portion 52c of the substrate 51 is calculated. RET2/RET1, which is the ratio of the phase difference (second phase difference) in the outer peripheral portion 52c to the phase difference (first phase difference) in the center portion 52a calculated from the average values RET1 and RET2, is 81%. Therefore, RET2/RET1 of the optical element 50 of the fifth embodiment is 97% or less.

(Appearance Evaluation after Endurance Test)

Since rising-up and peeling are not confirmed in the appearance observation after the completion of the temperature cycle test of the optical element 50 of the fifth embodiment, the appearance of the optical element 50 of the fifth embodiment is judged to be good (∘) as shown in Table 1. According to the fifth embodiment, even when the optical element 50 is affected by the environment, the occurrence of defective adhesion of the optical film 52 in the outer peripheral portion 52c of the optical element 50 can be suppressed. Similarly to the first embodiment, the optical element 50 of the fifth embodiment can be applied to various devices and apparatuses such as optical apparatuses, image pickup apparatuses, and display apparatuses.

The center angle CA of the predetermined area PA of the optical element 50 of the fifth embodiment is not limited to 90°. In a range where the RET2/RET1 of the optical element 50 is 97% or less, the center angle CA of the predetermined area PA may be larger than 90° or smaller than 90°. The optical film 52 may be heated by the heating member 79 in at least one portion of the outer peripheral portion of the substrate 51 of the optical element 50.

### Sixth Embodiment

### (Optical Element)

An optical element 60 of a sixth embodiment will now be described with reference to FIG. 10A and FIG. 10B. FIG. 10A and FIG. 10B are views showing the optical element 60 of the sixth embodiment. FIG. 10A is a front view of the optical element 60. FIG. 10B is a cross-sectional view of the optical element 60 taken along a line XB-XB of FIG. 10A. The optical element 60 includes a substrate 61, an optical film 62, and an adhesive layer 63. The substrate 61 has a convex curved surface portion 61a. The optical film 62 is bonded to the curved surface portion 61a of the substrate 61 through the adhesive layer 63. The adhesive layer 63 is formed of, for example, an optically transparent adhesive or glue.

### (Manufacturing Method of Optical Element)

The manufacturing apparatus 70 configured to manufacture the optical element 60 of the sixth embodiment is the same as that of the first embodiment, and therefore a description thereof is omitted. First, the substrate 61 made of plastic is provided. The curved surface portion 61a of the substrate 61 has a diameter of 45 mm. The substrate 61 is a convex lens made of plastic having a half open angle θ of 22°. Next, as the optical film 62, IQPE, which is the reflective polarizing film manufactured by 3M Company, is provided as in the first embodiment.

As in the first embodiment described with reference to FIG. 2A to FIG. 2G, the substrate 61 is arranged on the substrate holding portion 74 of the manufacturing apparatus 70, and the optical film 62 is arranged on the film holding portion 73. The bonding temperature of the optical film 62 is set to 150° C., and the optical film 62 is bonded to the substrate 61 through the adhesive layer 63 (bonding step). The substrate 61 to which the optical film 62 is bonded is taken out of the manufacturing apparatus 70, and an arcuate portion 61b indicated by a dotted line in FIG. 10A and FIG. 10B is cut out (cutting step). At least one location of the substrate 61 may be cut out so that a part of at least one portion of the outer peripheral portion of the substrate 61 to be post-heated remains. Thereafter, the outer peripheral portion (an arcuate area having a width of 4.5 mm from the end portion) of the substrate 61 is heated by the heating member 79 at a post-heating temperature of 200° C. (heating step). The post-heating temperature in the heating step is higher than the heating temperature in the bonding step. At least one portion of the outer peripheral portion of the substrate 61 to which the optical film 62 is bonded may be heated by the heating member 79. An unnecessary portion of the optical film 62 is cut out by applying the blade 80 along the outer edge of the substrate 61 to manufacture the optical element 60. The optical element 60 of the sixth embodiment is a reflective polarizing optical element in which the reflective polarizing film as the optical film 62 is bonded to the substrate 61 through the adhesive layer 63. In the sixth embodiment, at least one location of the substrate 61 is cut out before the heating step, but the present embodiment is not limited to this. After the heating step, at least one location of the substrate 61 may be cut out so that a part of at least one portion of the outer peripheral portion of the substrate 61 to be post-heated remains.

### (Phase Difference Measurement)

The optical element 60 of the sixth embodiment is evaluated using the phase difference measuring apparatus KOBRA. In the sixth embodiment, as shown in FIG. 10A, the optical film 62 having a missing circular shape is divided into a center portion 62a, a middle band portion 62b, and an outer peripheral portion 62c. An area within a diameter of 22.5 mm corresponding to a diameter of 50% from the center of the optical element 60 is defined as the center portion 62a. The average value RET1 of the phase difference (first phase difference) between the polarization component in the stretching direction and the polarization component in the direction orthogonal to the stretching direction in the center portion 62a of the substrate 61 is calculated. The area of the optical element 60 heated by the heating member 79, which is an arc-shaped area with a width of 4.5 mm from the end portion of the substrate 61 after removing the arcuate portion 61b, is defined as the outer peripheral portion 62c. The average value RET2 of the phase difference (second phase difference) between the polarization component in the stretching direction and the polarization component in the direction orthogonal to the stretching direction in the outer peripheral portion 62c (at least one portion of the outer peripheral portion before removing the arcuate portion 61b) of the substrate 61 is calculated. RET2/RET1, which is the ratio of the phase difference (second phase difference) in the outer peripheral portion 62c to the phase difference (first phase difference) of the center portion 62a calculated from the average values RET1 and RET2, is 91%. Therefore, RET2/RET1 of the optical element 60 of the sixth embodiment is 97% or less.

(Appearance Evaluation after Endurance Test)

Since rising-up and peeling are not confirmed in the appearance observation after the completion of the temperature cycle test of the optical element 60 of the sixth embodiment, the appearance of the optical element 60 of the sixth embodiment is judged to be good (o) as shown in Table 1. According to the sixth embodiment, even when the optical element 60 is affected by the environment, the occurrence of defective adhesion of the optical film 62 in the outer peripheral portion 62c of the optical element 60 can be suppressed. Similarly to the first embodiment, the optical element 60 of the sixth embodiment can be applied to various devices and apparatuses such as optical apparatuses, image pickup apparatuses, and display apparatuses.

In the sixth embodiment, the arcuate portion 61b is cut from the substrate 61 after the optical film 62 is bonded, but the shape of the portion cut from the substrate 61 is not limited to the arcuate shape, and may be other shapes such as an arc shape, a half-moon shape, etc. The portion cut from the substrate 61 is not limited to one location but a plurality of portions may be cut out at a plurality of locations. As long as the RET2/RET1 of the optical element 60 is within the range of 97% or less, at least one portion may be cut out from the substrate 61.

### COMPARATIVE EXAMPLE

### (Optical Element of Comparative Example)

An optical element 90 of a comparative example will now be described with reference to FIG. 11A and FIG. 11B. FIG. 11A and FIG. 11B are views showing the optical element 90 of the comparative example. FIG. 11A is a front view of the optical element 90. FIG. 11B is a cross-sectional view of the optical element 90 taken along a line XIB-XIB of FIG. 11A. The optical element 90 includes a substrate 91, an optical film 92, and an adhesive layer 93. The substrate 91 has a concave curved surface portion 91a. The optical film 92 is bonded to the curved surface portion 91a of the substrate 91 through the adhesive layer 93. The adhesive layer 93 is formed of, for example, an optically transparent adhesive or glue.

### (Manufacturing Method of Optical Element of Comparative Example)

The manufacturing apparatus 70 configured to manufacture the optical element 90 of the comparative example is the same as that of the first embodiment, and therefore a description thereof is omitted. First, the substrate 91 made of plastic is provided. The curved surface portion 91a of the substrate 91 has a diameter of 45 mm. The substrate 91 is a concave lens made of plastic having a half open angle θ of 22°. Next, as the optical film 92, IQPE, which is the reflective polarizing film manufactured by 3M Company, is provided as in the first embodiment.

As in the first embodiment described with reference to FIG. 2A to FIG. 2G, the substrate 91 is arranged on the substrate holding portion 74 of the manufacturing apparatus 70, and the optical film 92 is arranged on the film holding portion 73. The bonding temperature of the optical film 92 is set to 150° C., and the optical film 92 is bonded to the substrate 91 through the adhesive layer 93. After the substrate 91 to which the optical film 92 is bonded is taken out of the manufacturing apparatus 70, the heating step of heating the outer peripheral portion of the substrate 91 by the heating member 79 is not performed. An unnecessary portion of the optical film 92 is cut out by applying the blade 80 along the outer edge of the substrate 91 to manufacture the optical element 90. The optical element 90 of the comparative example is a reflective polarizing optical element in which the reflective polarizing film as the optical film 92 is bonded to the substrate 91 through the adhesive layer 93.

### (Phase Difference Measurement)

The optical element 90 of the comparative example is evaluated using the phase difference measuring apparatus KOBRA. In the comparative example, as shown in FIG. 11A, the optical film 92 is divided into a center portion 92a, a middle band portion 92b, and an outer peripheral portion 92c. An area within a diameter of 22.5 mm corresponding to a diameter of 50% from a center of the optical element 90 is defined as the center portion 92a. The average value RET1 of the phase difference (first phase difference) between the polarization component in the stretching direction and the polarization component in the direction orthogonal to the stretching direction in the center portion 92a of the substrate 91 is calculated. An area having a width of 4.5 mm from the end portion of the substrate 91 of the optical element 90 is defined as the outer peripheral portion 92c. The average value RET2 of the phase difference (second phase difference) between the polarization component in the stretching direction and the polarization component in the direction orthogonal to the stretching direction in the outer peripheral portion 92c of the substrate 91 is calculated. RET2/RET1, which is the ratio of the phase difference (second phase difference) in the outer peripheral portion 92c to the phase difference (first phase difference) in the center portion 92a calculated from the average values RET1 and RET2, is 101%. Therefore, RET2/RET1 of the optical element 90 of the comparative example is larger than 97%.

(Appearance Evaluation after Endurance Test)

Since rising-up and peeling are confirmed in the appearance observation after the completion of the temperature cycle test of the optical element 90 of the comparative example, the appearance of the optical element 90 of the comparative example is judged to be NG (x) as shown in Table 1.

The center portions 12a, 22a, 32a, 42a, 52a, and 62a of the substrates 11, 21, 31, 41, 51, and 61 are areas having the diameters corresponding to 50% of the diameters of the substrates 11, 21, 31, 41, 51, and 61 from the centers of the optical elements 10, 20, 30, 40, 50, and 60. The 50% of the diameter includes 49.5% to 50.4% of the diameter. However, the center portions 12a, 22a, 32a, 42a, 52a, and 62a may be areas having diameters corresponding to less than 50% of the diameters, 50% or more of the diameters, such as diameters corresponding to 40%, 45%, 55%, or 60% of the diameters.

The outer peripheral portions 12c, 22c, 32c, 42c, 52c, and 62c of the substrates 11, 21, 31, 41, 51, and 61 are areas having widths corresponding to 10% of the diameters of the substrates 11, 21, 31, 41, 51, and 61 from the end portions of the substrates 11, 21, 31, 41, 51, and 61. The 10% of the diameter includes 9.5% to 10.4% of the diameter. However, the outer peripheral portions 12c, 22c, 32c, 42c, 52c, and 62c may be areas having widths corresponding to 7%, 8%, 9%, 11%, 12%, or 13% of the diameters.

Although the substrates 11, 21, 31, 41, and 51 of the first to fifth embodiments are circular, the shapes of the substrates 11, 21, 31, 41, and 51 are not limited thereto. The substrates 11, 21, 31, 41, and 51 may be rectangular, rhombic, trapezoidal, triangular, polygonal, missing circular shaped or other shapes.

In the first to fourth embodiments, the optical films 12, 22, 32, and 42 are heated by the heating member 79 over substantially the entire area of the outer peripheral portions 12c, 22c, 32c, and 42c of the substrates 11, 21, 31, and 41 after bonding. However, the optical films 12, 22, 32, and 42 may be heated by the heating member 79 over at least one portions of the outer peripheral portions 12c, 22c, 32c, and 42c of the substrates 11, 21, 31, and 41 after bonding.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-179645, filed Oct. 15, 2024, which is hereby incorporated by reference herein in its entirety.

What is claimed is:

1. An optical element, comprising:
an optical film which is uniaxially oriented; and
a substrate,
wherein the optical film is bonded to a curved surface of the substrate through an adhesive layer, and
wherein a second phase difference between a polarization component in a stretching direction and a polarization component in a direction orthogonal to the stretching direction in at least a partial area of an outer peripheral portion of the substrate is smaller than a first phase difference between a polarization component in the stretching direction and a polarization component in the direction orthogonal to the stretching direction in a center portion of the substrate.

2. The optical element according to claim 1, wherein the optical film is a reflective polarizing film,
wherein the stretching direction is a reflection axis direction of the reflective polarizing film, and
wherein the direction orthogonal to the stretching direction is a transmission axis direction of the reflective polarizing film.

3. The optical element according to claim 1, wherein the optical film is a phase difference film,
wherein the stretching direction is a slow axis orientation of the phase difference film, and
wherein the direction orthogonal to the stretching direction is a fast axis orientation of the phase difference film.

4. The optical element according to claim 1, wherein a ratio of the second phase difference to the first phase difference is 97% or less.

5. The optical element according to claim 1, wherein the partial area having the second phase difference is located at each of opposite end portions of the substrate.

6. The optical element according to claim 1, wherein the adhesive layer is formed of an optically transparent adhesive or glue.

7. The optical element according to claim 1, wherein the substrate is circular,
wherein the center portion is an area of a diameter corresponding to 50% of a diameter of the substrate from a center of the substrate, and
wherein the outer peripheral portion is an area of a width corresponding to 10% of the diameter of the substrate from an end portion of the substrate.

8. The optical element according to claim 1, wherein the substrate is circular, rectangular, diamond-shaped, trapezoidal, triangular, polygonal, missing circular shaped or otherwise shaped.

9. An optical apparatus comprising:
a barrel; and
the optical element according to claim 1, arranged in the barrel.

10. An image pickup apparatus comprising:
a body;
the optical element according to claim 1; and
an image pickup element arranged in the body and configured to receive an image formed by the optical element.

11. A display apparatus comprising:
a housing;
an optical system arranged in the housing and including the optical element according to claim 1; and
a display portion configured to emit a light guided by the optical system.

12. A manufacturing method of an optical element comprising:
bonding an optical film which is uniaxially oriented to a curved surface of a substrate through an adhesive layer; and
heating at least one portion of an outer peripheral portion of the substrate to which the optical film is bonded.

13. The manufacturing method according to claim 12, wherein the bonding includes bonding so that a second phase difference between a polarization component in a stretching direction and a polarization component in a direction orthogonal to the stretching direction in at least a partial area of the outer peripheral portion of the substrate is smaller than a first phase difference between a polarization component in the stretching direction and a polarization component in the direction orthogonal to the stretching direction in a center portion of the substrate.

14. The manufacturing method according to claim 12, wherein the bonding is performed in a heated state, and
wherein a heating temperature in the heating is higher than a heating temperature in the bonding.

15. The manufacturing method according to claim 12, further comprising, after the heating, cutting out at least a location of the substrate so that a part of the at least one portion of the outer peripheral portion remains.

16. The manufacturing method according to claim 12, wherein the optical film is a reflective polarizing film or a phase difference film.
